(19) United States
(12) Patent Application Publication
(10) Pub. No.: US 2010/0106647 A1
(43) Pub. Date: Apr. 29, 2010

(54) METHOD AND SYSTEM FOR CLOSE RANGE COMMUNICATION USING AUDIO TONES

(76) Inventor: Raja Raman, Tamilnadu (IN)

Correspondence Address: ALIX YALE & RISTAS LLP, 750 MAIN STREET, SUITE 1400, HARTFORD, CT, 06103, US

(21) Appl. No.: 12/528,827

(22) PCT Filed: Feb. 26, 2008
(86) PCT No.: PCT/IN08/00110

§ 371 Date: Aug. 27, 2009

(30) Foreign Application Priority Data
Feb. 28, 2007 (IN) 408/CHE/2007

(51) Int. Cl. G06Q 20/00; H04L 27/00; H04L 9/00; G06F 11/07

(52) U.S. Cl. 705/67; 375/259; 380/255; 714/746; 714/E11.021

(57) ABSTRACT

The present invention relates to a method for close range secured communication using audio tones and a system for carrying out such method. The invention is related to the field of financial transactions through relatively-mobile devices using audio tones. More particularly, the present invention is directed to a method for communicating information between two mobile phones using the speaker and Mic of the mobile devices

### FIELD OF INVENTION

The present invention relates to a method for close range secured communication using audio tones and a system for carrying out such method. The invention is related to the field of financial transactions through relatively-mobile devices using audio tones. More particularly, the present invention is directed to a method for communicating information between two mobile phones using the speaker and Mic of the mobile devices. The communication using audio tones means according to the present invention is adapted for secured transactional purpose involving encrypted audio tone based transaction which would avoid the present day limitations of financial transactions such as those involving credit cards and internet facilities which are subject to possible electronic theft.

### BACKGROUND ART

The available prior disclosed knowledge in the related art describe methods of transactions often used for acquisition of goods and services with retailers and distributors either by traveling personally to a retail supplier for a face-to-face transaction paid for either in cash, by cheque, by credit card, or transferring funds electronically among the buyer's and seller's accounts. While a cash transaction is relatively secure, the process of bringing the cash to the retailer's place of business and of transporting purchased goods back to their place of use or storage often may not be secure. It is common experience while transacting money, the paper money can be forged, cheques can be misappropriated and fraudulently encashed/debited, credit cards also can be misappropriated or pass word key numbers fraudulently used including the threat from persons of acquaintance and electronic fund transfer may be vulnerable to errors and to electronic theft.

Other known methods of transactions involve using telephones as medium of communicating between the parties involved in any such transactions. Many of the above-described risks for face-to-face transactions are avoided by using the telephone as a medium for commerce. A telephone/telegraphic transaction may be much more efficient in time and in communications costs than traveling to a retailer's place of business. Although, the risks inherent to traveling and carrying cash are avoided in this method but telephone communications are precariously insecure and prone to being intercepted. Telephone transactions may require less staffing and facilities overhead from the standpoint of a retailer, yet such transactions still involve either human operators and are relatively time-inefficient, cumbersome, and often annoying voice menu systems and recorded-voice order-entry systems.

Transactions and e-commerce through the Internet is a relatively recent phenomenon wherein the Internet has emerged to become one of the fastest growing and most technologically sophisticated mediums for order entry. An Internet user can quickly conduct a comparative analysis of products, identify retailers and distributors for those products, place orders through relatively easy mouse and keyboard input, and pay for the transactions using relatively secure encrypted communications for the exchange of credit card information and other types of electronic funds transfer. The Internet provides a much richer communications medium than the telephone by providing the display of graphical information as well as text-based and sound-based information. A disadvantage of the Internet is that a user is generally required to use a personal computer, which is expensive to procure, and also costly to maintain over time, inconvenient to carry and use of credit cards and other online payments have been used for fraudulent purposes.

In the case of mobile or cellular phones, recent practices have shown “cloning” of cellular telephone, which entails intercepting telephone transmissions from a cellular telephone, to another cellular phone. The “cloned” telephones are typically sold on the “black” market. In these instances, the cellular telephone owner has no way of knowing whether, or when, his or her cellular transmissions are being intercepted and/or if and when a “cloned” cellular phone is created and/or is utilized on, or over, his or her cellular telephone account making it very dangerous for making any kind of transactions via a mobile/cellular phone, since any attempted misappropriation remains undetected. There is no known technology or any apparatus or method for preventing such unauthorized use.

A number of prior arts dealt with the aspect of securing business related exchange of information between concerned parties and means for authenticating identity of such persons or a device user.

U.S. Pat. No. 7,093,759 is directed to a Low Power Hand-Held Transaction Device which is basically a low-power hand-held device to scan an input (e.g. barcode, audio, manual entry) and send to a server over a telecom network to get more details on the input subject.

U.S. Pat. No. 6,014,441 is directed to a method and system for generation of tone signals over a transmission channel. This patent is about pre-recording of a users voice and converting it to amplified tones and storing in a central database. Later when the user requires to be authenticated, the recorded voice would be played into microphone-based system, typically a telephone that transmits this data as audio tones to a receiving system with access to a centralized database for authentication.

DE 4231789 provides a Remote Authorisation System For Transactions Using Credit Card and the disclosure in the patent is directed to a telephone/mobile unit that connects to a central server to transmit the credit card information directly as DTMF(Dual Tone Multi-Frequency) tones, to get a response authenticating/rejecting a particular transaction.

US published 20060190412 is directed to a method and system for preventing fraudulent use of credit cards and credit card information, and for preventing unauthorized access to restricted physical and virtual sites' this patent is about using cybercoupons which is a small card with optional memory, audio and display capabilities, to show a unique one-time use coupon number on screen or generate an audio tone for the coupon number. This would then be used to manually enter into the system that requires authentication or using the audio tones on a telecom network to connect to the server.

It would be apparent from the above prevailing state of the art that while transaction devices are made available for transacting of information the same continue to have limitations in terms of user friendly attributes and also security aspects. In particular, transaction devices which could enable financial transactions in a secured manner avoiding the present day limitations and concerns in the use of credit cards and the like for similar transactions need to be addressed by the art. There has thus been a growing and challenging need for providing a method for making such transactions secured such as on one hand to favour financial transactions and on the other hand be also user friendly and not very complex for ready use and application for regular financial transactions.

### OBJECTS OF THE INVENTION

It is thus the basic object of the present invention to provide a method and a system thereof, for close range communication involving audio tones which would be secured and authentic to favour financial transactions to the satisfaction of both the consumers and merchants involved in regular financial transactions and the like.

Another object of the present invention is directed to provide for a method and system thereof, to transact information involving simple and user friendly gadgets such as between two mobile phones using audio tones which would be secured and authentic to favour financial transactions to the satisfaction of both the consumers and merchants involved in regular financial transactions and the like.

A still further object of the present invention directed to provide for a method and system of close range communication wherein the information to be communicated is converted into secured audio signals facilitating financial transaction based communications.

According to yet another object of the present invention the same is directed to provide for a method and a system thereof for close range communication involving audio tones wherein the communication is established for a secured transactional purpose.

A still further object of the present invention directed to provide for a method and system of encryption based secured transactions involving audio tones that can be adapted for regular transactions of important and confidential nature such as financial transactions.

A still further object of the present invention wherein a method to perform commercial transactions using mobile phones of a vendor and consumer involving transferring transactional information between the mobile phones of the vendor and consumer using the built-in speaker and micro-phone as the communication devices with possible validation options can be communicated either through wired or wireless means.

According to yet another object of the present invention directed to a method to provide a close range communication between two relatively mobile devices adapted to a self-error correcting mechanism to reduce the transmission error between the mobile phones.

### SUMMARY OF THE INVENTION

Thus according to the basic aspect of the present invention there is provided a method for audio tone based close range secured communication of information using audio signals, audible and/or in-audible frequency, wherein each audio tone represents a byte of information between at least two or more mobile phones/wired devices each having built-in speaker and micro-phone comprising:
(a) generating said audio signals, audible and/or in-audible frequency, based encrypted bit information for the secured transaction by means of at least one relatively mobile information generating devices;
(b) receiving the said audio signals, audible and/or in-audible frequency, based encrypted bit information and decrypting the same in at least one relatively mobile information receiving device; and
(c) said generation and receipt of information being carried out via a central server maintained in operative communication between said relatively mobile information generating devices and relatively mobile information receiving device.

A further aspect of the present invention directed to a method for audio tone based close range transaction of information wherein the audio signals, audible and/or in-audible frequency, based encrypted bit information comprise information about the said relatively mobile information generating device.

A still further aspect of the present invention directed to a said method for audio tone based close range communication of information wherein the audio signals, audible and/or in-audible frequency, in the said relatively mobile information generating device are captured by the relatively mobile information receiving device for the said information transaction.

According to yet another significant aspect of the said method for audio tone based close range communication of information comprising carrying out validation checks of the information communicated between the said relatively mobile information generating device and the relatively mobile information receiving device through said operative central server connection, said audio tones used having self-error correcting mechanism to reduce the transmission error.

A still further important aspect of the present invention directed to a method for audio tone based close range communication of information wherein said encrypted information is applied on top of the well defined frequency signals to prevent information snooping for all security reasons.

A still further aspect of the present invention directed to a method for audio tone based close range communication of information wherein the encryption algorithm and the security keys associated with it can be transmitted as part of hand-shake communication prior to start of actual data transmission.

Importantly, according to the method for audio tone based close range communication of information of the present invention wherein the encoded frequency signals are flanked by synchronizing (bounding) bands of fixed frequency (different from data signals) and the whole sequence is continuously repeated and for validating the transmitted signal sequence an error correcting signal (or sequence of signals) is transmitted (flanked by another set of bounding bands) along with the data signals.

A further aspect of the method for audio tone based close range communication of information of the present invention wherein the amount of information transacted is based on the audio facilities of the information generating and capturing device.

Yet another aspect of the present invention directed to a method for audio tone based close range communication comprising selectively close range exchange of audio tone based transactions including identity information, device based authentication in consumer solutions and mobile commerce preferably in financial transactions.

According to an aspect of the present invention is directed to a system for audio tone based close range secured communication of information using audio signals, audible and/or in-audible frequency, wherein each audio tone represents a byte of information comprising:
(a) at least two or more mobile phones/wired devices each having built-in speaker and micro-phone;
(b) means for generating said audio signals, audible and/or in-audible frequency, based encrypted bit information by means of at least one relatively mobile information generating devices;
(c) means for receiving the said audio signals, audible and/or in-audible frequency, based encrypted bit information and decrypting the same in at least one relatively mobile information receiving device; and
(d) a central server means adapted for operative communication between said generated and received audio tone based information between said relatively mobile information generating devices and relatively mobile information receiving device.

A further aspect of the said system for audio tone based close range communication of information wherein the central server generates a unique sequence number (basic unit) valid for a one time use by a client application and associating it with a single client application.

A still further aspect of said system for audio tone based close range transaction of information wherein the client application would internally store an encrypted value which would be multiples of a basic unit.

A still further aspect of said system for audio tone based close range transaction of information wherein said audio signals, audible and/or in-audible frequency, based encrypted bit information and decrypting the same are received using a merchant application.

According to a further aspect of the said system for audio tone based close range communication of information wherein the audio signals, audible and/or in-audible frequency, based encrypted bit information comprise information about the said relatively mobile information generating device.

A still further aspect of said system for audio tone based close range transaction of information wherein the audio tones generated and received are adapted depending on the size of information being exchanged, audio signals selectively audible and/or in-audible frequency are used.

A still further aspect of the system for audio tone based close range transaction of information according to the present invention wherein the said relatively mobile information receiving device for the said information communication is adapted to capture the audio signals, audible and/or in-audible frequency, generated by the said relatively mobile information generating device.

A still further aspect of the present system for audio tone based close range communication of information comprising said server means adapted to carry out validation checks of the information communicated between the said relatively mobile information generating device and the relatively mobile information receiving device, said audio tones generated having built in error correction mechanisms.

Another aspect of the present invention directed to the system for audio tone based close range communication of information wherein the produced signal frequencies are sent to the speakers of the mobile device, the transmitted information in the form of signal is picked by the Mic of the receiving device by an application running in that device [of the receiver], the encoded frequency signals are flanked by synchronizing (bounding) bands of fixed frequency (different from data signals) and the whole sequence is continuously repeated and preferably for validating the transmitted signal sequence an error correcting signal (or sequence of signals) is transmitted (flanked by another set of bounding bands) along with the data signals.

A still further aspect of the present system for audio tone based close range communication of information comprising means adapted to support public/private key encryption mechanism.

Another aspect of the present invention directed to said system for audio tone based close range communication of information comprising platform independent communication.

According to a further aspect of the present system for audio tone based close range communication of information adapted for close range exchange of identity information, device based authentication in consumer solutions and mobile commerce.

### DETAILED DESCRIPTION OF THE INVENTION

The present invention is directed to providing for a method and system for close range communication between relatively mobile devices using audio tones. More particularly, the system of the invention adapted to communicate information between two mobile phones using the Speaker and Mic of the mobile devices. Said system of the present invention is further adapted to convert the information to be communicated into predefined or well-defined audio signals in the audible or in-audible frequency range by an application running in the transmitting mobile phone/device.

The present invention is, more particularly related to the field of financial transactions through relatively mobile devices using audio tones in a secured manner. To illustrate an embodiment of the invention there is defined the elements in the system such as out of the two mobile devices involved in the closed range communication directed to transaction or the like, according to the present invention, the initiating side (consumer) having a mobile device containing an application referred to as Consumer Application (CA) and the receiving/fulfillment side (merchant) would have another mobile/wired device containing another application referred to as Merchant Application (MA). Said Consumer Application (CA) of the system is adapted to store internally an encrypted value, which would be multiples of a basic unit, called System Unit (SU). A Central Server (CS) generates a System Unit (SU) and associates it with a single unique Consumer application (CA) device, at any given point of time. An SU is a unique sequence number valid for a one-time/single use by a Consumer Application (CA). Once used, the system unit (SU) is associated with a different Consumer Application communicating with a different Merchant Application (MA). The usage of System Unit (SU) means, performing a transaction in the system between a CA and another CA or MA. The desired close range communication/Transaction is performed in the system by transmitting/receiving/exchanging audio tones between two mobile devices. A System Unit (SU) is valid only in the system wherein it is being used and which is controlled by its Central Server (CS). Each such system having its own Central Server (CS) shall cater to different CA and MA in alternative embodiments. A System Unit (SU) as defined, is not an identity of a CA or MA, but denotes a certain temporary value being held within a CA or MA of the system, directed to enabling a secured transaction between two mobile devices in a localized manner. The system according to the invention is also adapted to provide for a self-error correcting mechanism to reduce the transmission error between the mobile phones.

The present method of close range communication/transaction between two mobile devices provide for a method of encryption that can be applied on top of the well-defined frequency signals to prevent information snooping for all security reasons, and said transaction/communication wherein the encryption algorithm and the security keys associated with it can be transmitted as part of hand-shake communication prior to start of actual data transmission as audio tones. The method of the present invention is further adapted to perform commercial transactions using mobile phones of a vendor and consumer by means of transferring transactional information between the mobile phones of the vendor/merchant and consumer using the built-in speaker and micro-phone as the communication devices which in turn are validated by a central server wherein the communication can either be communicated through wired or wireless means. The produced signal frequencies are sent to the speakers of the mobile device. The transmitted information in the form of signal is picked up by the Mic of the receiving device by an application running in that device. The encoded frequency signals are flanked by synchronizing (bounding) bands of fixed frequency that are different from data signals and the whole sequence is continuously repeated. The method further provides for the sake of validating the transmitted signal sequence, means for an error-correcting signal or sequence of signals transmitted flanked by another set of bounding bands along with the data signals.

The system according to the present invention directed to closed range communication using audio tones is intended to be owned by a physical authority, such as any enterprise body like a financial institution/bank, loyalty management company, telecom company, retailer etc., wherein a consumer desirous to take part in said secure short range communication/transaction needs to sign up in said system and is created as a valid user in the system's Central Server (CS). The consumer's account so created can now hold a few System units (SUs), based on the initial terms of account creation or if the consumer wishes to deposit money in equivalent System units (SUs). Thus a Consumer can deposit SU's in his account by exchanging monetary units in a prepaid/postpaid form as agreed in the terms of account creation with the owner of the system.

An intending customer desirous to avail the facility of the system using closed range communication over mobile devices using audio tones according to the present invention, needs to install the Client Application (CA) which is downloaded from the Central Server (CS). The consumer also needs to get from said Central server (CS), the authentication details for using the CA. The Consumer Application (CA) has the capability to obtain the System Units (SU's) identified by the SU numbers, which is in multiples of encrypted data modules stored in the Central Server for identifiable association with the consumer's account in the Central Server(CS). The owner/service provider of the system defines the valid merchants where the SU's are accepted, based on stored encrypted modular data in the Central Server (CS). All such merchants in the system need to install the Merchant Application (MA) for validity/authentication, which can be downloaded from the Central Server (CS). The merchants intending to establish communication link with any desirous Consumer for favored secured transaction over close range mobile device using audio tones, also need to get the authentication details from the Central Server, for using said Merchant Application (MA).

Thus the method according to the present invention for the close range communication/transaction to be performed by the system between two mobile devices using audio tones, a consumer need to move to a valid merchant's location with mobile device and wishes to perform a transaction with the merchant. The consumer then activates the Consumer Application (CA) software already downloaded in his mobile device from the Central Server (CS) by providing his authentication details. Similarly, the merchant invokes the MA in his mobile/wired device by providing his authentication details. The consumer device is kept close to the merchant device, so that their respective speaker/Mic (or mouth-piece) modules are in a proximity range which allows them to exchange audio tones. Based on the available SU's in the CA, the consumer initiates the transaction by invoking a function in the CA. The CA's speaker emits a audio tone, representing the CA and SU numbers (encrypted), which are received by the MA's mic (or mouth-piece). The transmission correctness can be ensured using CRC checks etc. Once the MA receives a valid transmission from the CA, the MA id, CA id and the SU number are sent over a telecom network by the MA to the Central Server (CS).

The CS validates the association of the SU with the CA and authenticates the transaction if such an association exists. Otherwise the CS rejects the authentication request. If the transaction is authenticated, the CS changes the association of the SU from the CA's account to MA's account. And if the transaction is rejected, no changes are done by the CS. Once the MA receives the authenticated response, the merchant assumes the SUs to be valid and completes the transaction by delivery of goods, thus completing, a transaction in cash or kind, depending on service rendered by the MA.

It is thus possible by way of the present invention to provide for the desired method and system for close range communication involving audio tones which would be secured and authentic to favour financial transactions to the satisfaction of both the consumers and merchants involved in regular financial transactions and the like.

1-21. (canceled)

22. A method for audio tone based close range secured communication of information using audio signals, audible and/or in-audible frequency, wherein each audio tone represents a byte of information between at least two mobile phones or wired devices each having built-in speaker and micro-phone comprising:
(a) generating said audio signals, audible and/or in-audible frequency, based encrypted bit information for the secured transaction by means of at least one relatively mobile information generating device;
(b) receiving the said audio signals, audible and/or in-audible frequency, based encrypted bit information and decrypting the same in at least one relatively mobile information receiving device; and
(c) carrying out said generation and receipt of information via a central server maintained in operative communication between said relatively mobile information generating devices and relatively mobile information receiving device.

23. A method for audio tone based close range secured communication of information according to claim 22 wherein the audio signals, audible and/or in-audible frequency, based encrypted bit information comprise information about the said relatively mobile information generating device.

24. A method for audio tone based close range secured communication of information according to claim 23 wherein the audio signals, audible and/or in-audible frequency, in the said relatively mobile information generating device are captured by the relatively mobile information receiving device for the said information transaction.

25. A method for audio tone based close range secured communication of information according to claim 24 comprising carrying out validation checks of the information communicated between the said relatively mobile information generating device and the relatively mobile information receiving device through said operative central server connection, said audio tones used having self-error correcting mechanism to reduce the transmission error.

26. A method for audio tone based close range secured communication of information according to claim 25 wherein said encrypted information is applied on top of the well defined frequency signals to prevent information snooping for all security reasons.

27. A method for audio tone based close range secured communication of information according to claim 26 wherein the encryption algorithm and the security keys associated with it can be transmitted as part of hand-shake communication prior to start of actual data transmission.

28. A method for audio tone based close range secured communication of information according to claim 27 wherein the encoded frequency signals are flanked by synchronizing (bounding) bands of fixed frequency (different from data signals) and the whole sequence is continuously repeated and for validating the transmitted signal sequence an error correcting signal (or sequence of signals) is transmitted (flanked by another set of bounding bands) along with the data signals.

29. A method for audio tone based close range secured communication of information according to claim 28 wherein the amount of information transacted is based on the audio facilities of the information generating and capturing device.

30. A method for audio tone based close range secured communication of information according to claim 29 including selectively close range exchange of audio tone based transactions including identity information, device based authentication in consumer solutions and mobile commerce preferably in financial transactions.

31. A system for audio tone based close range secured communication of information using audio signals, audible and/or in-audible frequency, wherein each audio tone represents a byte of information comprising:
(a) at least two mobile phones or wired devices each having built-in speaker and micro-phone;
(b) means for generating said audio signals, audible and/or in-audible frequency, based encrypted bit information by means of at least one relatively mobile information generating device;
(c) means for receiving the said audio signals, audible and/or in-audible frequency, based encrypted bit information and decrypting the same in at least one relatively mobile information receiving device; and
(d) a central server means adapted for operative communication between said generated and received audio tone based information between said relatively mobile information generating devices and relatively mobile information receiving device.

32. A system for audio tone based close range secured communication of information according to claim 31 wherein the central server generates a unique sequence number (basic unit) valid for a one time use by a client application and associating it with a single client application.

33. A system for audio tone based close range secured communication of information according to claim 32 wherein the client application would internally store an encrypted value which would be multiples of a basic unit.

34. A system for audio tone based close range secured communication of information according to claim 31 wherein said audio signals, audible and/or in-audible frequency, based encrypted bit information and decrypting the same are received using a merchant application.

35. A system for audio tone based close range secured communication of information according to claim 31 wherein the audio signals, audible and/or in-audible frequency, based encrypted bit information comprise information about the said relatively mobile information generating device.

36. A system for audio tone based close range secured communication of information according to claim 35 wherein the audio tones generated and received are adapted depending on the size of information being exchanged, audio signals selectively audible and/or in-audible frequency are used.

37. A system for audio tone based close range secured communication of information according to claim 36 wherein the said relatively mobile information receiving device for the said information communication is adapted to capture the audio signals, audible and/or in-audible frequency, generated by the said relatively mobile information generating device.

38. A system for audio tone based close range secured communication of information according to claim 37 including said server means adapted to carry out validation checks of the information communicated between the said relatively mobile information generating device and the relatively mobile information receiving device, said audio tones generated having built in error correction mechanisms.

39. A system for audio tone based close range secured communication of information according to claim 38 wherein the produced signal frequencies are sent to the speakers of the mobile device, the transmitted information in the form of signal is picked by the Mic of the receiving device by an application running in the receiving device, the encoded frequency signals are flanked by synchronizing (bounding) bands of fixed frequency (different from data signals) and the whole sequence is continuously repeated and preferably for validating the transmitted signal sequence an error correcting signal (or sequence of signals) is transmitted (flanked by another set of bounding bands) along with the data signals.

40. A system for audio tone based close range secured communication of information according to claim 39 including means adapted to support public/private key encryption mechanism.

41. A system for audio tone based close range secured communication of information according to claim 40 including platform independent communications.

42. A system for audio tone based close range secured communication of information according to claim 41 adapted for close range exchange of identity information, device based authentication in consumer solutions and mobile commerce.
